(19) United States
(12) Patent Application Publication
(10) Pub. No.: US 2010/0127152 A1
(43) Pub. Date: May 27, 2010

(54) Remote control carrier

(76) Inventor: Paul A. Bower, Gladwin, MI (US)

Correspondence Address: JOHN MCCULLOCH, 5291 COLONY DRIVE NORTH,, STE. 1, SAGINAW, MI, 48638, US

(21) Appl. No.: 12/313,984

(22) Filed: Nov. 26, 2008

(51) Int. Cl. A47G 29/00; F16M 11/02

(52) U.S. Cl. 248/690; 248/682

(57) ABSTRACT

A carrier for use in removably attaching a remote control unit to a person's hand comprises a support section having a portion adapted to overlie and be secured to the user's hand and wrist in position to receive a sleeve within which the remote control unit is accommodated. The support section of the carrier and a portion of the sleeve are provided with cooperable hook and loop fasteners which securely, but separably, fasten the sleeve and support section to one another. The sleeve has along one side thereof a window formed of transparent material which is sufficiently deformable and resilient as to enable an externally applied force to be transmitted to keys or switches underlying the window. The remote control body has a projection which extends through an opening in the retaining sleeve for releasably retaining the remote control body within the sleeve.

This invention relates to a carrier for a remote control unit of the kind adapted to be held in the hand of a person for operating an electronic device from a remote location.

### BACKGROUND OF THE INVENTION

A remote control unit commonly is used by a person to control various electronic apparatus such as televisions, radios, audio recording and playing devices, power point display operators, and the like. In some instances the person who operates a remote control has infirmities which make difficult the positioning or adjustment of the control in condition for convenient operation. In other instances, and particularly in those cases wherein the remote control operation is required to be interactive with the apparatus to be controlled, such as performing exercise routines, or in participating in a pro-active game, the necessity of the person's operating the control unit to move about sometimes results in the person dropping or otherwise losing control over the unit.

A principal object of the invention is to provide a carrier for a remote control device which enables the aforementioned disadvantages to be overcome without imposing a burden on the user.

### SUMMARY OF THE INVENTION

A remote control carrier constructed in accordance with a preferred embodiment of the invention comprises a support section for attachment to a person's hand and a sleeve in which the remote control body is accommodated. The support section is of such area and configuration as to overlie the palm portion of a person's hand and has at one end thereof an attaching strap which removably encircles the user's wrist. The opposite end of the support section is of such length as to extend beyond the palm so as partially to overlie the person's fingers. The support section has attaching straps which may extend over the back of the person's hand so as to secure the support section in place on the person's hand.

The carrier also includes a sleeve having a configuration complementary to that of the remote control device which is to be accommodated in the sleeve. The sleeve is of such size as snugly, but slideably, to accommodate the remote control unit. The sleeve which is adapted to overlie the user's palm has adjacent one end thereof an opening for the accommodation of a retaining projection forming part of the remote control body. Such projection may, in many cases, constitute a trigger or switch which forms part of the circuitry of the remote control.

Remote control units conventionally have manually operable keys which are operable by a user's thumb and bear indicia indicative of the function to be controlled by a particular switch. To enable the keys to be visible to the user of the carrier disclosed herein the sleeve has at least a portion thereof which is transparent and overlies the keys. The material from which the transparent sleeve portion is formed should be sufficiently pliable and deformable as to enable a force applied externally of the sleeve to be transmitted through the transparent sleeve portion to the underlying key.

The supporting section of the attachment carries on its exposed surface one part, either the hooks or the loops, of a hook and loop fastener. That part of the sleeve which is separate from the transparent portion carries the other part of the hook and loop fastener. The remote control unit, encased in the sleeve, may be placed in the palm portion of the attachment's support section so that the hook and loop fastener portions will cooperate with one another and securely, but removably, couple the remote control unit to the support section.

### THE DRAWINGS

A carrier construction according to the invention is illustrated in the accompanying drawings wherein:

FIG. 1 is an isometric view illustrating a carrier attachment applied to the hand and wrist of a person with the remote control body within a sleeve which is secured to that portion of the attachment which overlies the person's palm;

FIG. 2 is an isometric, exploded view of the remote control unit and its accommodating sleeve; and

FIG. 3 is a plan view of the attachment portion of the carrier.

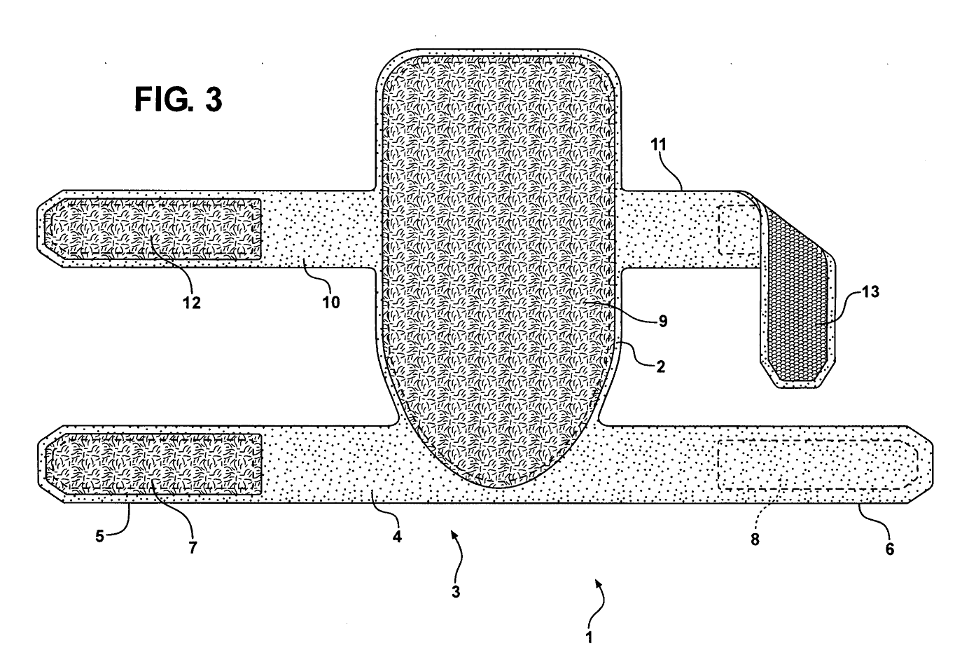

### THE DISCLOSED EMBODIMENT

Apparatus constructed in accordance with the invention comprises an attachment 1 having a support section 2 formed of a pliable material such as textile, leather, or a suitable plastic and being of such area and configuration as to overlie the palm area of a person's hand and at least a portion of the fingers adjacent the palm. At one end of the section 2 is a first securing means 3 comprising a flexible strap 4 having opposite ends 5 and 6. One end 5 has a known loop or hook fastener section 7 affixed to one surface thereof, whereas the other end 6 has the other hook or loop section fastener section 8 secured to one side thereof. The strap is of such length as to encircle a person's wrist adjacent the hand and be secured in wrist-encircling condition by placing the loop and hook sections in overlying positions and pressing them against each other.

One surface of the support section 2 has secured thereto a loop or hook portion 9 of a loop and hook fastener.

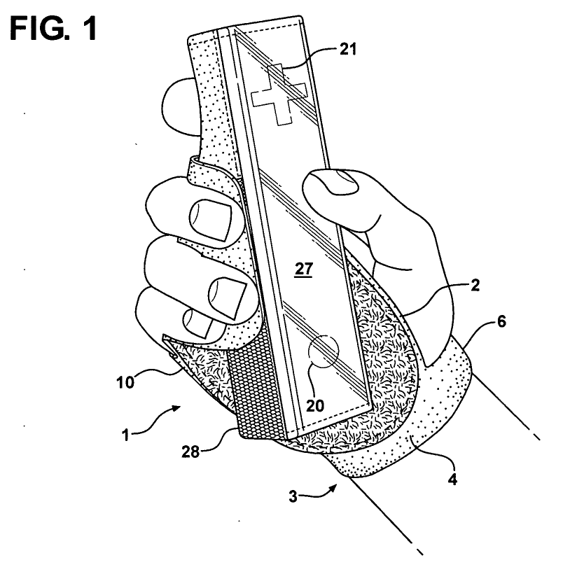

Spaced from the attaching strap 4 and approximately midway between the opposite ends of the support section 2 is a second securing means comprising two straps 10 and 11 which are secured to and extend in opposite directions from the support section 2. Adjacent the free end of the strap section 10 is the first part of a loop and hook fastener section 12 and adjacent the free end of the strap 11 is the second part 13 of the loop and hook fastener. The straps 10 and 11 are of such length that, in conjunction with the support section 2, they encircle the hand of the person so that the support section 2 overlies the person's palm and the ends of the straps overlie the back of the person's hand. The fastener sections 12 and 13 cooperate with one another to provide a releasable attachment of the attachment 1 to the person's hand and wrist as is shown in FIG. 1.

The apparatus thus far described is adapted to support a remote control unit 15 comprising an elongate body or housing 16 within which is accommodated electrical circuitry (not shown) adapted to operate an electronic device (not shown), such as a television set, a radio, a monitor, or any other device adapted for control from a remote position.

The remote control unit body is thicker at one end 17 than at the opposite end 18 and at the juncture of the different thickness ends is a projection 19 which may constitute a control, such as a switch actuator or trigger, useful in connection with the operation of the remotely controlled device. The remote control unit is formed of durable, rigid, suitable material of conventional construction.

A typical remote unit has a plurality of manually operable switches or keys such as those illustrated at 20 and 21 and which are so located as to be operable by a person's thumb or forefinger. Such keys or actuators conventionally bear indicia (not shown) indicative of the function resulting from the operation of such keys. The keys are so located that, when the remote control unit is held in a person's hands, the keys will be within comfortable reach of such person's thumb or forefinger.

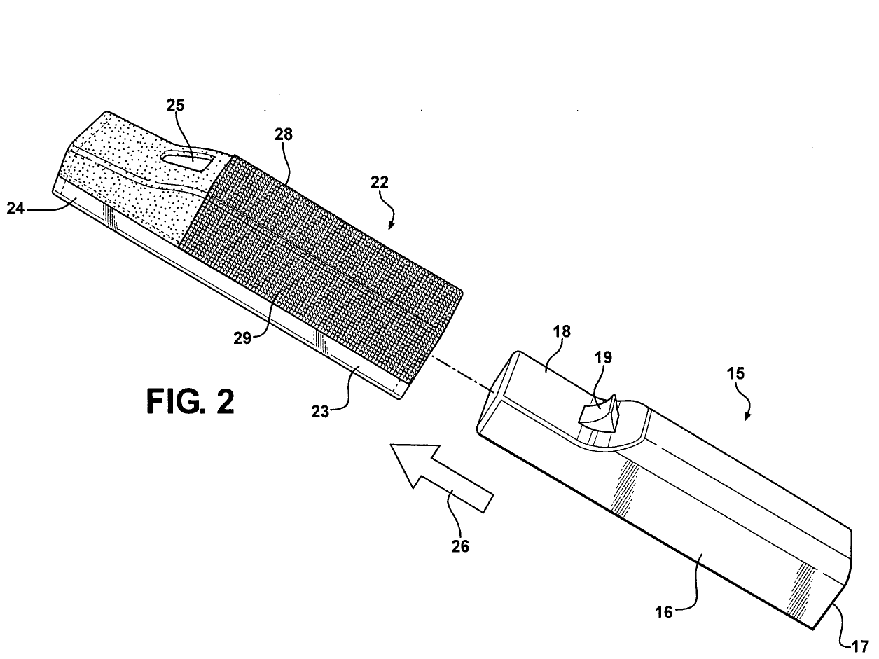

The carrier apparatus constructed in accordance with the invention includes a sleeve 22 that is adapted to accommodate the remote control body 15. The sleeve has a configuration complementary to that of the remote control body in that it includes one end 23 of such size as snugly to correspond to the size of the larger end 17 of the remote control body and, at the opposite end 24, a configuration complementary to that of the smaller end 18 of the remote control body. The end 24 of the sleeve also has therein an opening 25 of such size and so located as snugly to accommodate the projection 19 of the remote control body 16. The arrangement is such that the remote control unit 15 may be accommodated in the sleeve 22 by sliding the control unit into the sleeve in the direction of the arrow 26 shown in FIG. 2. As the unit slides into the sleeve the projection 19 will extend through the opening 25 so as to be accessible to the user who will be able to operate the projection if, as is customary, it constitutes a displaceable switch actuator or trigger. The extension of the projection through the opening 25 also functions to preclude inadvertent separation of the remote control body and the sleeve by preventing relative movement of the body 15 and the sleeve 22 in the direction opposite that indicated by the arrow 26.

It is desirable that the keys 20 and 21, as well as their indicia, be visible when the remote control body is within the sleeve 22. Accordingly, one side of the sleeve is a window 27 formed of a suitable, transparent plastic material of known kind which is sufficiently pliable and deformable as to enable a force applied externally on the window 27 to be transmitted to the underlying keys 20 and 21, thereby enabling them to function in the same manner as if they were wholly exposed to the touch of a person's thumb or fingers.

The remaining material forming the sleeve 22 includes a section 28 which carries on its exterior either the loop or hook portion of a loop and hook fastener assembly. The support section 2 of the attachment 1 overlies the side 28 of the remote control body when the latter is within the sleeve so as to be in a position to be engaged by the loop or hook fastener section carried by the support section, thereby enabling the sleeve to be fastened securely to the user's hand as is shown in FIG. 1. The remote control body thus will be securely, but releasably, secured to the attachment 1 by the cooperative loop and hook fastening pairs, and the remote control body will be securely, but removably, secured within the sleeve by the projection 19 which can be actuated in such manner as to enable removal of the control body from the sleeve when desired.

The separability of the sleeve from the overlying palm portion of the support section makes it possible for the user to place the sleeve and the remote control unit therein in any selected one of a number of adjusted positions which is the most comfortable and adaptable to the size of the hand and fingers of the user. The carrier thus is capable of being used by adults and children whose physical sizes vary considerably.

The secure retention of the remote control body in the sleeve and the secure retention of the sleeve by the support section of the attachment, coupled with the ability of the thumb and fingers of the user to grip the sleeve, as is illustrated in FIG. 1, provides an extremely secure, but separable, attachment of the remote control unit to a person's hand. The disclosed embodiment is representative of a presently preferred form of the invention, but is intended to be illustrative rather than definitive thereof. The invention is defined in the claims.

I claim:

1. A remote control carrier for attachment to the palm of a person's hand comprising a support section of such size and configuration as to overlie at least a portion of the palm area of a person's hand; releasable securing means for releasable attachment to such person's wrist; a sleeve for snugly and slideably accommodating a remote control body having a retainer projection thereon, said sleeve having an opening therein in such position as removably to accommodate said projection; and separable fastener means carried by said support section and said sleeve for releasably fastening said sleeve to said support section in such position as to enable said projection to extend through said opening; said securing means and said fastening means being operable releasably to secure said support section and said sleeve to such person's hand with said sleeve occupying a position overlying such person's palm.

2. The carrier according to claim 1 wherein at least a portion of said sleeve is formed of transparent material.

3. The carrier according to claim 2 wherein at least a portion of said transparent material is sufficiently deformable as to enable a force applied to said portion of said transparent material to be transmitted thereby to said remote control body.

4. The carrier according to claim 1 wherein said separable fastening means comprises cooperable hook and loop fasteners on said support section and on said sleeve.

5. The carrier according to claim 1 wherein said remote control body has opposite ends of different thicknesses, said sleeve having opposite ends corresponding to the opposite ends of said body.

6. The carrier according to claim 1 wherein said remote control body has keys in a selected area on one side thereof, said sleeve being transparent in an area corresponding to said selected area of said body, thereby enabling said keys to be visible through said transparent area.

7. The carrier according to claim 1 wherein said separable fastening means is of such area as to enable said sleeve to occupy any selected one of a number of adjusted positions relative to said support section.

8. A carrier for attaching a remote control body to a person's hand, said carrier comprising a support section having opposite sides and being of such area and configuration as to overlie a portion of the palm of one hand of such person; first securing means at one end of said support section for encircling the wrist of said person; second securing means between opposite ends of said support section for encircling said hand of such person with a substantial portion of said support section overlying the palm of such person's hand; a sleeve for snugly and slideably accommodating said remote control body, said body having a retaining projection extending therefrom, said sleeve having an opening therein in such position as to accommodate said projection; and releasable fastening means carried by said sleeve and by said support section for releasably fastening said sleeve and said support section to one another in any selected one of a plurality of adjusted positions of said sleeve in each of which said projection is accommodated in said opening.

9. The carrier according to claim 8 wherein a selected area of said sleeve is formed of transparent material.

10. The carrier according to claim 9 wherein said selected area of said sleeve is formed of pliable, deformable material.

11. The carrier according to claim 8 wherein a selected area of said sleeve is transparent and formed of material sufficiently pliable and deformable as to enable a force applied externally to said selected area to be transmitted through said selected area of said material.

12. The carrier according to claim 8 wherein said support section is of such length between its opposite ends as to enable that end opposite said one end to extend beyond said body and overlie an adjacent side of said sleeve, said releasable fastening means securing said one side of said sleeve to said support section.

13. The carrier according to claim 12 wherein said support section is of such length as to enable that end thereof opposite said one end to be pressed against said one side of said sleeve by such person's fingers.

14. The carrier according to claim 8 wherein each of said first and second securing means comprises separable straps.
